(19) United States
(12) Patent Application Publication
(10) Pub. No.: US 2004/0217638 A1
(43) Pub. Date: Nov. 4, 2004

(54) Fold flat recliner mechanism

(75) Inventor: Yi Shao, Canton, MI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/831,520

(22) Filed: Apr. 23, 2004

Related U.S. Application Data
(60) Provisional application No. 60/465,446, filed on Apr. 25, 2003.

(51) Int. Cl. B60N 2/22

(52) U.S. Cl. 297/378.14

(57) ABSTRACT

A vehicle seat includes a fold flat recliner mechanism for reclining the seatback during occupant use and for folding the seatback to a position above the seat base during occupant non-use. The fold flat recliner mechanism includes a fold flat latch member for automatically, positively locking the seatback in the fold flat position. The vehicle seat includes a handle member for activating the recliner mechanism to adjust the recliner mechanism during occupant use and the same handle member may be used to activate the fold flat latch member to release the latch and unlock the seatback from the fold flat position and allow the seatback to be moved toward the design position.

### CROSS-REFERENCE TO RELATED PATENT APPLICATIONS

This application is an application claiming the benefit, under 35 USC 119(e), of U.S. Provisional Application 60/465,446, filed Apr. 25, 2003, incorporated herein by reference in its entirety.

### BACKGROUND OF THE INVENTION

The present invention relates generally to the field of adjustment or recliner mechanisms for use in positioning a seat back with respect to a seat base in a vehicle seat. More particularly, the present invention relates to a fold flat recliner mechanism for use on a vehicle seat wherein the recliner mechanism is capable of adjusting the position of the seat back with respect to the seat base and providing additional seat position functions in a single handle actuated recliner mechanism.

It is well known to provide a recliner mechanism in a vehicle seat to allow a seat occupant to adjust the position of the seat back with respect to the seat base. Numerous types of recliner mechanisms are known for providing this function.

Various vehicle seats have been developed with seat back adjusting or reclining mechanisms that provide for the reclining angle of the seat back to be adjusted, that provide for rotation of the seat back to a forward dump position for easy entry (E-Z entry) to the area of the vehicle behind the seat assembly and that provide for rotation of the seat back to a substantially flat position over the seat bottom for storage of the seat within the vehicle or for storage of the seat when removed from the vehicle. Many of these vehicle seats, however, suffer from having multiple actuating handles and levers to operate the vehicle seat recline or adjustment mechanism.

For example, U.S. Pat. No. 6,139,104, to Brewer, discloses a vehicle seat back adjusting mechanism for adjusting the recline position of the seat back, the rotation of the seat back to a forward dump easy entry position and the rotation of the seat back to a fold flat position. The seat back adjusting mechanism of the Brewer '104 reference is disclosed as including a mounting member coupled to a horizontal seat bottom or base, an intermediate arm rotatably coupled to the mounting member by a primary pivot and an upper arm rotatably coupled to the intermediate arm, by a secondary pivot and the seat back is attached to the upper arm for rotation relative to the mounting member about either the primary pivot or the secondary pivot. Brewer '104 further discloses that a recliner is operatively associated with the mounting member and the intermediate arm to hold the intermediate arm in one of a variety of adjusted, reclined positions about the primary pivot and is controlled by a dump latch coupled to the intermediate arm. When the dump latch is released, the intermediate arm is free to rotate forward about the primary pivot to a forward dumped E-Z entry position and the recliner stays in its adjusted position when the seat back is dumped forward. Brewer '104 further discloses that an upper arm latch is provided to hold the upper arm in a fixed position relative to the intermediate arm such that when the upper arm latch is released, the upper arm and the seat back rotate about the secondary pivot to a generally horizontal fold flat stowed position over the seat base. A release linkage is provided between a recliner release pivot and the upper arm latch to release the upper arm latch via actuation of the recliner release pivot. The upper arm latch is released as the seat back rotates to the foremost recline position. Once the seat back rotates forward to the foremost recline position, the upper latch is released, allowing the seat back to continue forward rotation about the secondary pivot to the fold flat position. In the fold flat position, the upper arm latch reengages with the upper arm to lock the upper arm in the fold flat position.

The recliner release pivot is subsequently actuated to again release the upper arm latch to enable return of the seat back rearward to the foremost recline position. The upper arm latch then reengages to hold the upper arm in position about the secondary pivot and the recliner is reengaged to hold the intermediate arm in a fixed position about the primary pivot. Thus, while the Brewer '104 reference discloses one embodiment of an integrated seat control mechanism, it requires a dual pivot recliner mechanism and a specific operating control sequence to realize the benefits of a single handle control.

Another known example for adjusting a seat back is U.S. Pat. No. 6,152,533, to Smuk, which discloses a recliner mechanism including a first handle control means to effect rotation of the seat back and downward movement of the seat base frame for providing E-Z Entry or easier access behind the seat. The Smuk '533 reference discloses that a second control handle is required to independently adjust the recline position of the seat back. While the Smuk '533 device claims to improve over the prior art, it still requires separate handles for multiple seat functions including, seat recline, seat dump and E-Z entry. Similar to the '533 Smuk reference, U.S. Pat. No. 6,336,679 to Smuk discloses a multiple handle vehicle seat control mechanism. The Smuk '679 reference discloses that a first handle is used to provide seat recline adjust and E-Z entry activation and that a second handle is used to provide seat back fold or dump and E-Z entry lockout.

U.S. Pat. No. 6,328,381, to Smuk, discloses a single control handle release mechanism for a vehicle seat hinge including a mounting plate attached to a seat base, a sector plate pivotally mounted on the mounting plate for selective pivotal movement about a first lower pivot axis, and a control plate attached to a seat back, the control plate being pivotally mounted on the sector plate for selective pivotal movement about a second upper pivot axis.

The Smuk '381 reference discloses that the vehicle seat back is pivotally movable about the first lower pivot axis between a plurality of angular positions and forwardly foldable about the second upper pivot axis between a design or occupant use position and a forwardly dumped position. Smuk '381 further discloses that the seat back recliner mechanism includes a release mechanism comprising a primary latch that pivotally fixes the sector plate with respect to the mounting plate, and a secondary latch that pivotally fixes the rotational control plate with respect to the sector plate. Smuk '381 also discloses the provision of a member having one end connected to the seat base and a second end connected to the secondary latch for releasing the secondary latch and allowing the seat back to fold when the seat back is moved with respect to the seat base beyond a predetermined position.

The Smuk '381 reference further discloses that the upper-pivot mechanism for folding the seat back flat with the seat base includes a means for releasably locking the vehicle seatback means 28 in the forwardly dumped position. In particular, the Smuk '381 reference discloses that a notch 56 is disposed in the rotational control plate 50 and a projecting tooth member 77 is disposed on a cam member 72 for co-operative interlocking with the notch 56 when the vehicle seatback means 28 is in the forwardly dumped position. The Smuk '381 reference further discloses that the co-operating profiles of the notch 56 and the tooth member 77 are shaped such that manual lifting of the seatback means 28 with only slightly more than a minimal force toward the design position causes unlocking of the notch 56 and the tooth member 77 with respect to each other, thus permitting the seatback to be pivoted about the second upper pivot axis to the design position.

Thus, what is needed is a recliner mechanism that is capable of positively locking the seatback in the folded position such that the seatback cannot be simply moved toward the design position by the application of a relatively low amount of force. Further, it would be advantageous to provide a recliner mechanism for a fold flat vehicle seat wherein the recliner mechanism can positively lock the seatback in the folded forward position and the recliner mechanism is designed to require the user to activate a member to release the seatback from the folded position and allow the seatback to be moved toward the design position.

It would be further advantageous to provide such a recliner mechanism for a fold flat vehicle seat wherein the recliner mechanism can positively lock the seatback in the folded forward position and the recliner mechanism is designed to require the user to activate a member to release the seatback from the folded position and allow the seatback to be moved toward the design position wherein a single handle operates both the recliner mechanism and a latch mechanism for locking the seatback in the folded forward position.

### SUMMARY OF THE INVENTION

There is provided a vehicle seat comprising a seat base and a seat back coupled to the seat base. The seat back has a design position and a folded position. A recliner mechanism is coupled to the seat base and seat back. The recliner mechanism is configured to adjust the angular position of the seat back with respect to the seat base about a first axis and for folding the seat back on top of the seat base about a second axis. A latch mechanism is coupled to the recliner mechanism and configured to selectively prevent the seat back from being removed from the folded position to the design position. The latch mechanism can be configured to automatically lock the seat back in the folded position. A handle coupled to the latch mechanism can also be used to activate the recliner mechanism.

There is also provided a method for locking a seat back of a vehicle seat in a folded position. The vehicle seat includes a seat base and a seat back, with the seat back having a design position and a folded position. A recliner mechanism is coupled to the seat base and seat back and configured to adjust the angular position of the seat back with respect to the seat base about a first axis and for folding the seat back on top of the seat base about a second axis. The method comprises the steps of providing a latch mechanism which is configured to selectively prevent the seat back from being moved from the folded position to the design position. Coupling the latch mechanism to the recliner mechanism. Attaching a handle to the latch mechanism, wherein the handle activates the latch mechanism. The latch mechanism can include a locking pawl member that is configured to automatically lock the seat back in a folded position. The method can include a step of biasing the locking pawl member in a locking position.

Other ways in which the above-referenced features are accomplished will become apparent to those skilled in the art after they have read this specification, and such other ways are deemed by the present inventor to fall within the scope of the present invention.

### BRIEF DESCRIPTION OF THE DRAWINGS

FIG. 1 is a partial perspective view of a vehicle seat including recliner mechanism including a seatback fold flat latch mechanism according to the present invention;

FIG. 2 is a perspective view of the recliner mechanism of the vehicle seat of FIG. 1 including a seatback fold flat latch mechanism according to the present invention;

FIG. 3 is a partial perspective view of the recliner mechanism of FIG. 2 showing the detail of the fold flat latch mechanism according to the present invention; and

FIG. 4 is a partial side view of a recliner mechanism including the fold flat latch mechanism according to the present invention.

### DETAILED DESCRIPTION OF THE PREFERRED EMBODIMENT

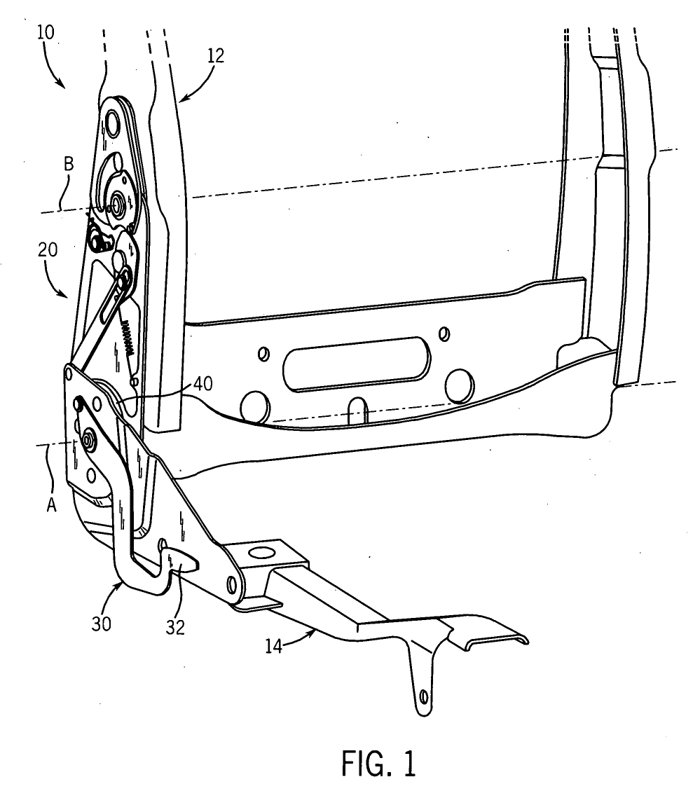

Referring generally to FIGS. 1 through 4 and in particular to FIG. 1, there is shown a vehicle seat 10 having supporting frame members corresponding to a seatback 12 and a seat base 14. The vehicle seat 10 further includes a recliner mechanism 20 for adjusting the angular position of the seatback 12 with respect to the seat base 14 about a first axis A and for folding the seatback 12 on top of the seat base 14 about a second axis B. The reclining mechanism 20 is based upon and operates the same as the known recliner mechanism design disclosed and shown in U.S. Pat. No. 6,328,381, to Smuk, entitled Single Control Release Handle Mechanism for Use with a Vehicle Seat, the disclosure of which is incorporated herein by reference. However, notwithstanding the above, it is possible that the recliner mechanism 20 used in conjunction with the present invention may utilize alternative designs and arrangements except as identified herein.

The recliner mechanism 20 includes a handle member 30 connected to the recliner mechanism 20 to rotate about the axis A and to activate a discontinuous round recliner mechanism 40. The handle member 30 includes a first end portion 32 adapted for a user to grip the handle member 30 and cause the handle member 30 to rotate on the axis A.

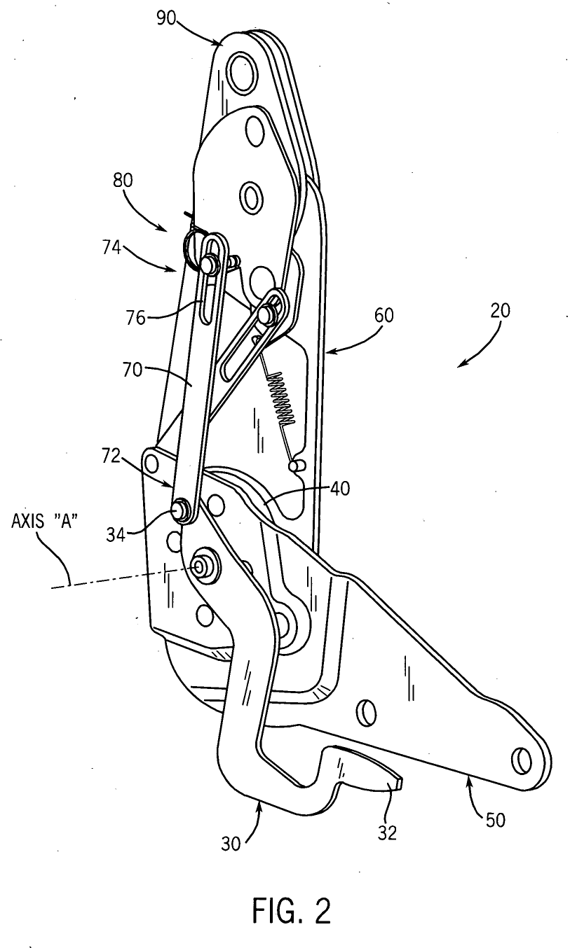

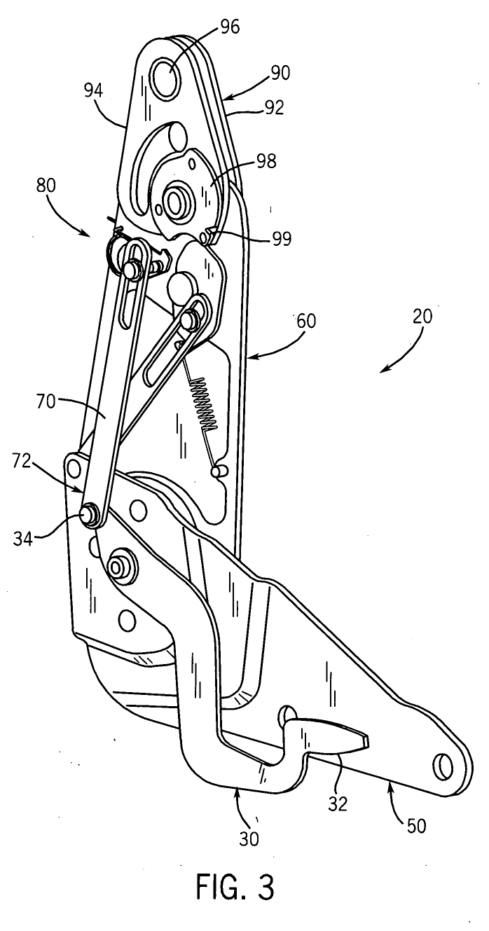

Referring now in particular to FIGS. 2 and 3, the handle member includes a second end portion 34 disposed distal the first end portion 32 and preferably on the opposite side of where the handle member 30 pivots on the axis A. The recliner mechanism 20 further includes a lower or mounting plate 50 and a link member or linkage #1 connected to a cam, and a middle sector plate 60 similar to that disclosed in the '381 patent to Smuk.

The recliner mechanism 20 further includes a second link member 70 or linkage #2 having a first end 71 pivotally connected to the second end 34 of the handle member 30. The second link member 70 further includes a second end 74 having a slot 76 located therein similar to the first linkage #1. The first end 74 of the second link member 70 is connected to a fold flat locking mechanism 80 for locking seatback 12, associated with a sector 90, in a fold flat position with respect to the seat base 14, associated with the mounting plate 50.

The sector 90 preferably includes first and second members 92 and 94 attached to pivot on the axis B and are pinned together using a pin 96 for connection with the seatback 12. The sector 90 includes a third sector member 98 also pivotally connected on the axis B and attached to rotate with the sector 90. The third sector 98 includes a notch 99 located in a periphery thereof and rotatable with the third sector 98 which rotates with the sector 90 along with the seatback 12. The third sector 98 rotates with the sector 90 when the recliner mechanism 20 is rotate forward to a position where a latch mechanism 100 releases the sector 90 as described in detail in the '381 patent.

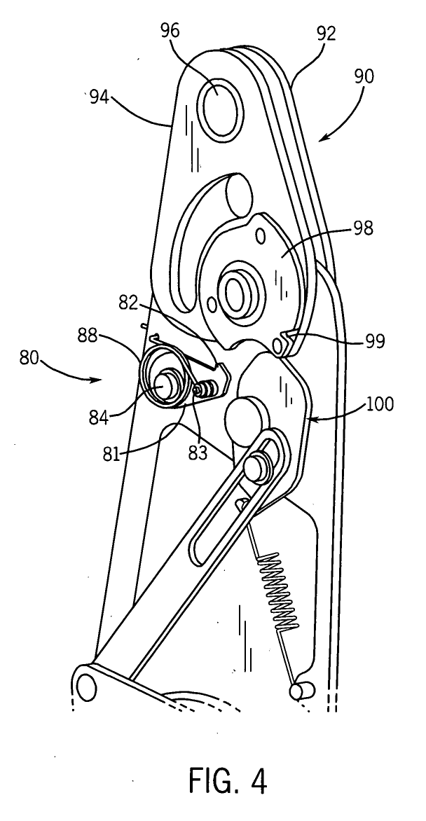

The fold flat lock mechanism 80 is shown in detail in FIGS. 3 and 4 and includes a locking pawl member 81 having a locking tab 82 located thereon. The locking pawl member 81 preferably includes a post 83 or other member for connecting the pawl 81 to the slot 76 of the second end 74 of the second linkage 70. The slot 76 allows the pin 83 to move in the slot 76 toward the first end 72 of the second linkage 70 when the occupant reclines the seatback 12 with respect to the seat base 14. When the seatback 12 is rotate forward, the post 83 moves in the slot toward the distal point of the second end 74 until it reaches the end of the slot 76 causing the locking pawl member 81 to pivot on a post 84 connected to the sector 60.

The locking pawl member is preferably biased in a first or locking direction by a spring or other biasing type device 88 having one end connected to the post 83 and an other end anchored to the sector 60. The locking tab 82 is designed to align with the notch 99 of the third sector 98 such that when the seatback 12 is rotated toward the fold flat position, the locking tab 82 of the pawl member 81 will be received in the notch 99 and the locking tab 82 will prevent further rotation of the third sector 98 and the seatback 12.

Further, the interface between the locking tab 82 and the notch 99 is designed to prevent an occupant simply forcing the seatback 12 from the fold flat position. When a user desires to move the seatback 12 from the fold flat position, the user grips the end 32 of the handle member 30 and rotates the handle member on the axis A by lifting the end 32 thereby also rotating the second end 34 of the handle member 30.

As the second end 34 rotates, the second linkage 70 moves with the second end 34 and the distal end of the slot 76 moves toward the post 83 and catches the post 83. As the user continues to move the handle member 30, the second link member 70 moves the post 83 thereby causing the pawl member 81 to rotate or pivot on the post 84 causing the locking tab 82 to be removed from the notch 99 of the third sector member 98 and unlocking the seatback 12. At this point, the seatback 12 may be moved from the fold flat position by rotation about the axis B and toward the design position.

While a preferred embodiment of the invention has been described in connection with the illustrations, and various modifications and alternatives thereto have been referred to in the written text, the present invention generally relates to a single handle member, fold flat, seat back lock mechanism for use with a foldable vehicle seat to provide a locking mechanism that will prevent the seatback from being easily or unintentionally moved from the fold flat position toward the design position. The invention is therefore not to be limited to the materials, shapes, orientations and proportions illustrated and described.

1. A vehicle seat comprising:
a seat base;
a seat back coupled to the seat base, with the seat back having a design position and a folded position;
a recliner mechanism coupled to the seat base and seat back and configured to adjust the angular position of the seat back with respect to the seat base about a first axis and for folding the seat back on top of the seat base about a second axis; and
a latch mechanism coupled to the recliner mechanism and configured to selectively prevent the seat back from being moved from the folded position to the design position.

2. The vehicle seat of claim 1, wherein the latch mechanism is activated by a handle.

3. The vehicle seat of claim 2, wherein the handle is coupled to the latch mechanism with a link member.

4. The vehicle seat of claim 2, wherein the recliner mechanism is activated by the handle.

5. The vehicle seat of claim 1, wherein the latch mechanism is configured to automatically lock the seat back in the folded position.

6. The vehicle seat of claim 5, wherein the latch mechanism includes a locking pawl member biased, by biasing member, in a locking position.

7. A method for locking a seat back of a vehicle seat in a folded position, the vehicle seat including a seat base and seat back, with the seat back having a design position and a folded position, with a recliner mechanism coupled to the seat base and seat back and configured to adjust the angular position of the seat back with respect to the seat base about a first axis and for folding the seat back on top of the seat base about a second axis, the method comprising the steps of:
providing a latch mechanism, configured to selectively prevent the seat back from being moved from the folded position to the design position;
coupling the latch mechanism to the recliner mechanism; and
attaching a handle to the latch mechanism, wherein the handle activates the latch mechanism.

8. The method of claim 7, including the step of configuring the handle to activate each of the latch mechanism and the recliner mechanism.

9. The method of claim 7, wherein the latch mechanism includes a locking pawl member and is configured to automatically lock the seat back in the folded position.

10. The method of claim 9, including the step of biasing the locking pawl member in a locking position.
